(19) United States
(12) Patent Application Publication
(10) Pub. No.: US 2006/0075143 A1
(43) Pub. Date: Apr. 6, 2006

(54) Administration system for administration target devices, data server and branch server for use in said system

(75) Inventor: Masato Fujii, Nagaokakyo-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Technologies, Inc., Tokyo (JP)

(21) Appl. No.: 11/011,142

(22) Filed: Dec. 15, 2004

(30) Foreign Application Priority Data
Sep. 30, 2004 (JP) 2004-288354

(51) Int. Cl. G06F 15/16

(52) U.S. Cl. 709/248

(57) ABSTRACT

An administration system for an administration target device includes at least one branch server that collects data from the administration target device, and a data server that integrally administers the data of each branch server. Each branch server and the data server are synchronized in data so that data held by one of the branch server or the data server can be held by the other.

This application claims priority under 35 U.S.C. § 119 to Japanese Patent Application No. 2004-288354 filed on Sep. 30, 2004, the entire disclosure of which is incorporated herein by reference in its entirety.

### BACKGROUND OF THE INVENTION

1. Field of the Invention

The present invention relates to an administration system for administration target devices for administering administration target devices, such as various information devices including an image forming apparatus. It also relates to a data server and a branch server for use in the system.

2. Description of the Related Art

The following description sets forth the inventor's knowledge of related art and problems therein and should not be construed as an admission of knowledge in the prior art.

In companies, etc., having a hierarchical organization including, e.g., a head office, branches, and sales branches, it has been conventionally performed that one or a plurality of administration target devices (e.g., image forming apparatus) belonging to each branch or sales branch that performs the maintenance thereof are administrated by a data server of the head office via a branch server to thereby integrally administrate all of the administration target devices.

As an example of such administration system for integrally administering a plurality of administration target devices existing hierarchically, Japanese Unexamined Laid-open Patent Publication No. H11-353145 proposes a two-layered type administration system in which administrative information owned by a first administration server is transmitted to a second administration server on a network and a method for providing the administrative information.

However, in the conventional administration system, when the data server integrally administrating data is changed into a new server, it takes huge amounts of time to backup data from the current data server and transfer the backup data to a new data server. Therefore, in the administration system continuously monitoring administration target devices, it was inevitable to stop the administration during the changing operation period, causing inconvenience.

Furthermore, in cases where the branches and/or sales branches, etc., are abolished or merged, it becomes necessary to delete the data of the branches, etc., to be abolished since such data becomes unnecessary. However, in the case of integrally administering huge amount of data, it takes a time to extract the data to be deleted from the huge amount of data, and therefore it was inefficient.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide an administration system for administration target devices capable of easily cope with a change of a data server or consolidation and integration of branches, sales branches, etc.

Among other potential advantages, some embodiments can provide a data server for use in the system.

Among other potential advantages, some embodiments can provide a branch server for use in the system.

According to a first aspect of the preferred embodiment of the present invention, an administration system for an administration target device, comprises:

at least one branch server that collects data from the administration target device; and

a data server that integrally administers the data of each branch server,

wherein each branch server and the data server are synchronized in data so that data held by one of the branch server and the data server can be held by the other.

According to a second aspect of the preferred embodiment of the present invention, an administration system for an administration target device, comprises:

at least one branch server that collects the data from the administration target device; and

a data server that integrally administers the data of each branch server,

wherein the data server holds data of each branch server in the state in which the data is separated every branch server without merging them, and processes the data as coherent data based on the data separated every branch server.

According to a third aspect of the preferred embodiment of the present invention, a data server for use in an administration system for an administration target device, comprises:

at least one branch server that collects data from the administration target device; and

a data server that integrally administers the data of each branch server,

wherein each branch server and the data server are synchronized in data so that data held by one of the branch server and the data server can be held by the other.

According to a fourth aspect of the preferred embodiment of the present invention, a data server for use in an administration system for an administration target device, comprises:

at least one branch server that collects data from the administration target device; and

a data server that integrally administers the data of each branch server,

wherein the data server holds the data of each branch server in the state in which the data is separated every branch server without merging them, and processes the data as coherent data based on the data separated every branch server.

According to a fifth aspect of the preferred embodiment of the present invention, a branch server for use in an administration system for an administration target device, comprises:

at least one branch server that collects data from the administration target device; and

a data server that integrally administers the data of each branch server,

wherein each branch server and the data server are synchronized in data so that data held by one of the branch server and the data server can be held by the other.

According to a sixth aspect of the preferred embodiment of the present invention, a branch server for use in an administration system for administration target devices, comprises:

at least one branch server that collects data from the administration target device; and

a data server that integrally administers the data of each branch server,

wherein the data server holds data of each branch server in the state in which the data is separated for every branch server without making merging them, and processes the data as coherent data based on the data separated every branch server.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a structural view showing an entire administration system according to one embodiment of the present invention;

FIG. 2 shows data flows in the administration system shown in FIG. 1;

FIG. 3 is an explanatory view showing the case in which a branch center transmits the data of the collected administration target device to the data center;

FIG. 4 is an explanatory view showing the case in which the data center directly collects data from the administration target devices;

FIG. 5 is an explanatory view showing the case of making an urgent communication to the person in charge of the administration target devices from a branch center;

FIG. 6 is a flowchart showing the operation to be performed when the branch center received data; and

FIG. 7 is a flowchart showing the operation to be performed when the data center received data.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

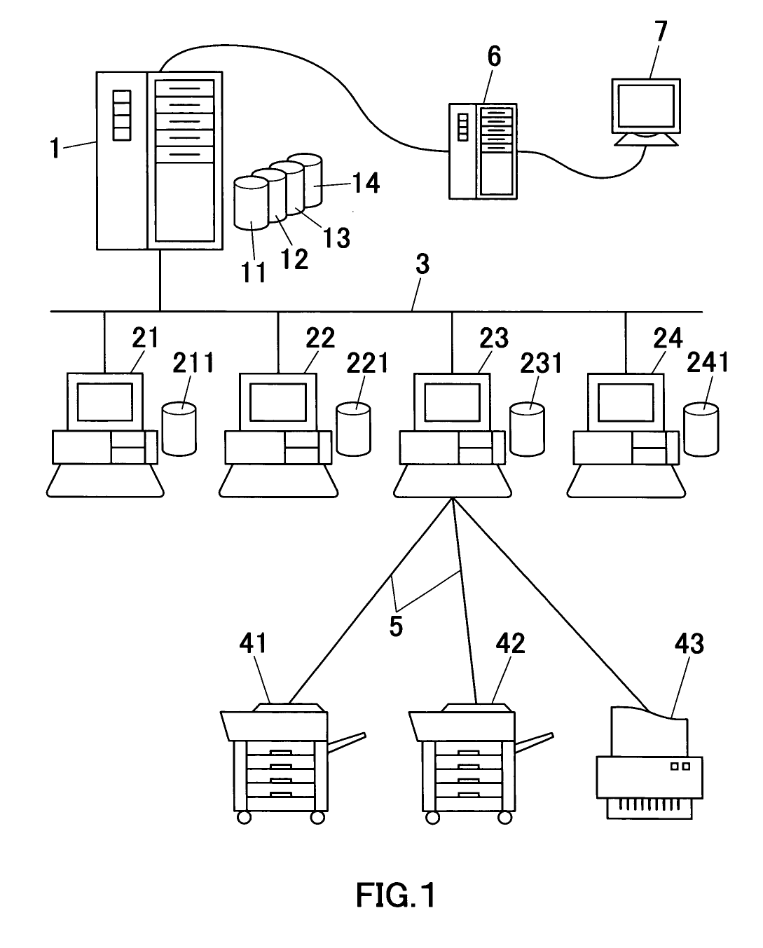

FIG. 1 is a block diagram showing an administration system according to one embodiment of the present invention. In this embodiment, administration target devices are information equipments. The following explanation will be directed to the case in which the information equipments are image forming apparatus, such as a printer, a copying machine, and a facsimile machine.

As shown in FIG. 1, in this administration system, a data server 1 (also referred to as “data center”) and a plurality of branch servers (also referred to as “branch center”) 21 to 24 are directly connected via a network 3.

The data center 1 is installed, for example, in the head office, and integrally administers management data of all information equipments.

The branch centers 21 to 24 are installed in branches, sales branches, etc. As represented by the branch center 23, to the branch centers 21 to 24, one or a plurality of information equipments (image forming apparatuses) 41 to 43 administered by respective branch center are connected via the network 5. Accordingly, each branch centers 21 to 24 can collect administrative data of these information equipments 41 to 43, such as count information which is the number of image forming. As will be mentioned later, the data center 1 can also collect administrative data from the information equipments 41 to 43 directly via the networks 3 and 5.

To the data center 1, an application server 6 is connected such that a communication can be established therebetween. This application server 6 has a function of making a user terminal 7 display the data stored in the data center 1 or transmit the setting data inputted from the user terminal 7 to the data center 1 in accordance with a request of the user from the user terminal 7 connected to the application server 6.

Each branch center 21 to 24 is provided with a data base 211 to 241 for accumulating the administrative data, etc., collected from the information equipments 41 to 43. On the other hand, the data center 1 has data bases 11 to 14 each having the same data as that of the data base 211 to 241 of each branch center 21 to 24 every data branch center in an independent manner. In FIG. 1, data bases 11, 12, 13 and 14 of the data center 1 correspond to the data base 211 of the branch center 21, the data base 221 of the branch center 22, the data base 231 of the branch center 23 and the data base 241 of the branch center 24, respectively.

Branch centers 21 to 24 and the data center 1 are synchronized in data so that, when either one of branch centers or the data center obtains new data, the other obtains the new data. In other words, the data collected by one of branch centers 21 to 24 from an information equipment 41 to 43 is transmitted to the data center 1, and saved in a data base 11 to 14 in the data center 1 corresponding to each branch center 21 to 24. Furthermore, when predetermined setting data is inputted by, e.g., a user into the data center 1, the data center 1 makes the setting data reflect in its own system, and also transmits the data to a required branch center 21 to 24 so as to be reflected to the system of the branch center.

As mentioned above, the data center 1 and each branch center 21 to 24 are synchronized in data so as to hold the same data, and that the data center 1 has the same data base as that of each branch center 21 to 24 every branch center 21 to 24 in an independent state without uniting data. The reasons are as follows.

That is, in the case of changing a data center 1, it is necessary to transfer the data to a new data center 1. In such a case, if the branch centers 21 to 24 hold the same data as that of the data center 1, the new data center 1 can have the same data as the data owned by the data center by sending the data held by each branch centers 21 to 24 to the new data center 1. This enables a quick start operation of the new data center. Accordingly, it becomes unnecessary to transfer a huge quantity of backup data to the new data center 1 from the previous data center, enabling a prompt action.

Furthermore, the data center 1 holds the data bases 11 to 14 of the same contents as that of each branch centers 21 to 24 every branch center 21 to 24 in a state in which the data bases are independent from each other. Therefore, even in cases where one or a plurality of branch centers 21 to 24 become unnecessary due to consolidation and integration of branches, sales branches, etc., it is enough for the data center 1 to delete only the data base corresponding to the branch center which became unnecessary among the data bases 11 to 14. Thus, it becomes unnecessary to separate and extract the data of the corresponding branch center from a huge amount of data, which was required in the case where all of the data of branch centers 21 to 24 are stored in one data base. This enables high-speed processing.

As for user accessible data, the data center 1 processes the separated data bases 11 to 14 as coherent data. Accordingly, a user can browse any data without recognizing that data is stored separately.

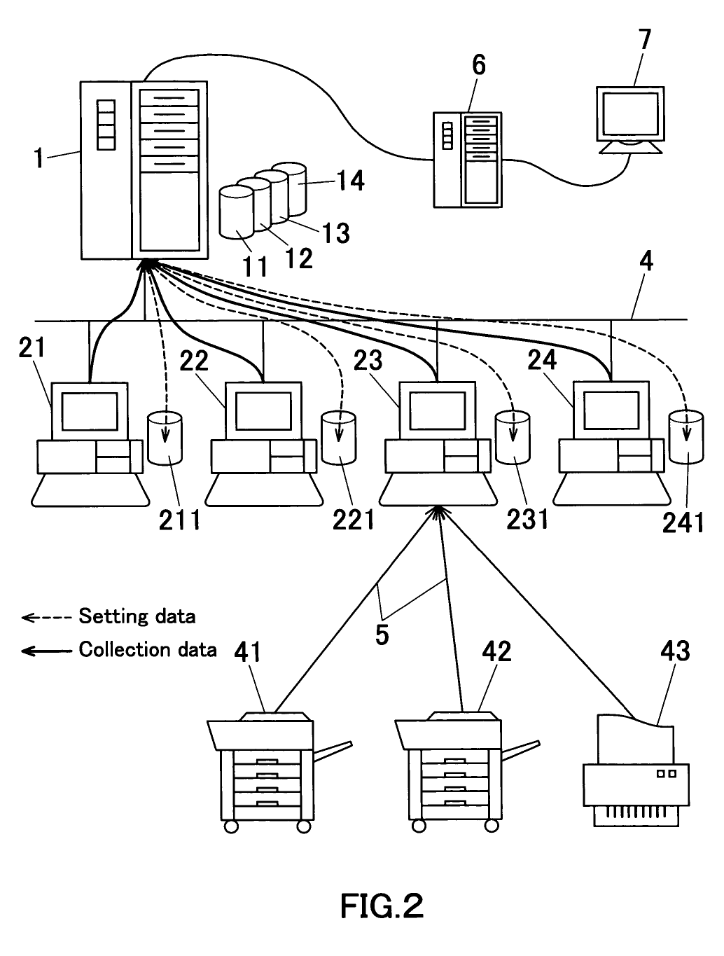

FIG. 2 is an explanatory view showing data flows between the data center 1 and each branch centers 21 to 24.

In FIG. 2, the solid arrowed lines show flows of administrative data collected by the branch centers 21 to 24 from the information equipments 41 to 43, while the dashed arrowed lines show flows of setting data by users.

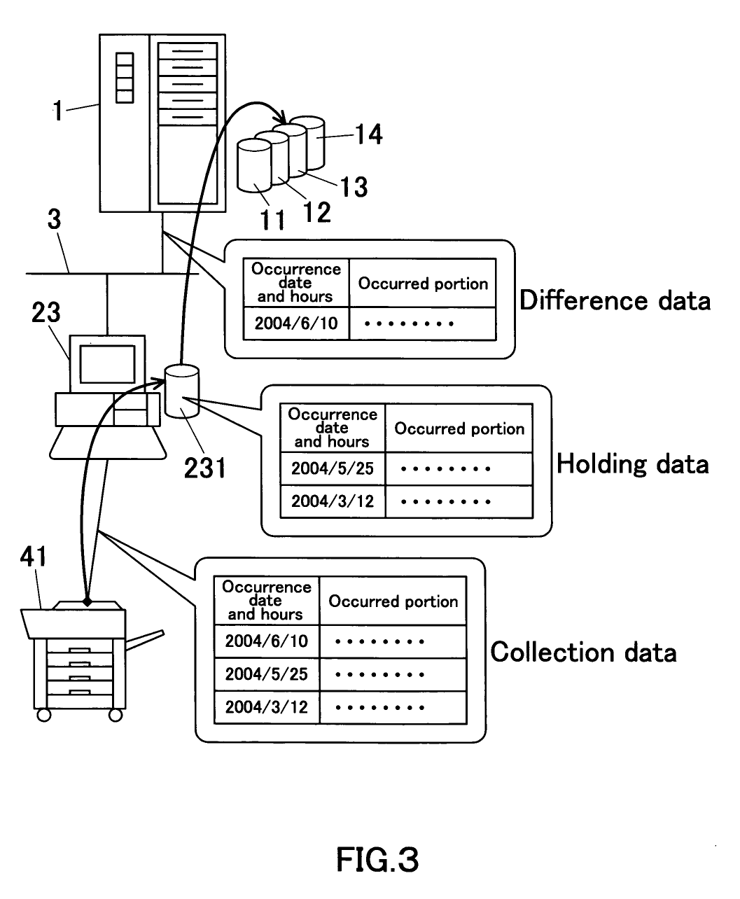

The branch centers 21 to 24 collect administrative data from the information equipments 41 to 43, and as shown by the solid arrowed lines, transmit the data to the data center 1. At this time, in this embodiment, each branch center 21 to 24 does not transmit all of the administrative data. As shown in FIG. 3, each branch center creates difference data of the newest collection data and its own holding data, or the difference data other than the collection data already transmitted to the data center 1, and transmits only the difference data to the data center 1. For this reason, the branch centers 21 to 24 can simply transmit necessary minimum data, enabling simplified transmitting processing. In FIG. 3, administrative data showing occurrence of paper jams, etc., in the information equipments 41 to 43 is exemplified. In this case, difference data is created based on the occurrence date and hour.

In the data center 1 received the difference data, the received difference data is stored in the corresponding data base 11 to 14 of the branches 21 to 24. In this case, since what is necessary is just to accumulate and store only the necessary minimum difference data, the storing processing can be simplified. Furthermore, the same administrative data can be held in the data center 1 and branch centers 21 to 24.

On the other hand, when a user accessed the application server 6 from the user terminal 7 and performed, for example, input setting of, e.g., user account information, customer information, this setting data is transmitted to the data center 1 from the application server 6 and reflected in the system of the data center 1. Simultaneously, as shown by the dashed arrowed line in FIG. 2, the setting data is also transmitted to a related branch center 21 to 24 from the data center 1 and reflected in the system of the branch center 21 to 24. Accordingly, the setting data inputted by the user is also held as the same data in the data center 1 and the branch center 21 to 24.

Thus, data can be synchronized between the data center 1 and the branch center 21 to 24.

At the time of changing the data center 1, the data collection processing of the branch centers 21 to 24 is suspended first. Next, an address of the new data center 1 is inputted to instruct a transfer of the data. Then, the branch centers 21 to 24 ask the data transfer destination to the new data center 1, and transmit all the data held in their own data bases 211 to 214 to the specified destination.

After a completion of the data transfer, branch centers 21 to 24 notify the transfer completion of the data center 1. Upon receiving a notice of the transfer completion, the data center 1 takes out the transmitted data from the specified destination to the branch centers 21 to 24 as the data transfer destination, and adds as a new data base 1. After the completion of the additional processing, the data center 1 deletes the data file transferred from the branch centers 21 to 24.

The branch centers 21 to 24 check the file that was transferred by themselves periodically, and discriminate whether the file was deleted or not. If deleted, the branch centers discriminate that the additional processing by the data center 1 was completed, and resume the stopped data collection activity to perform the same usual processing performed before the change of the data center 1.

Such processing is performed about each branch center 21 to 24, and therefore in the newly changed data center 1 the same contents of the data bases 11 to 14 as those of the data bases 211 to 241 exist in a dissociated manner.

On the other hand, in cases where some branch centers 21 to 24 become unnecessary due to consolidation and integration of branches etc., only the data base corresponding to the branch center is deleted from the data center 1.

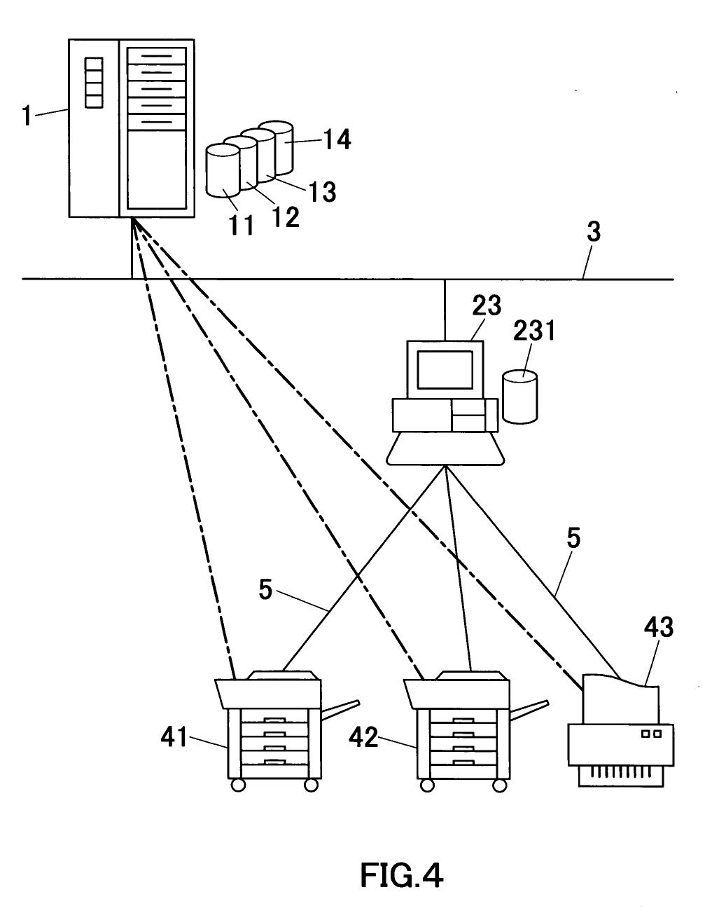

Next, in cases where a branch center 21 to 24 becomes inoperative for a certain reason, as shown in FIG. 4 by arrowed chain-lines, the data center 1 collects data by directly accessing the information equipment 41 to 43 that the branch center 21 to 24 performs data collection via networks 3 and 5. Although this is processing for emergency purposes, since the data center 1 holds the same data as that of the branch center 21 to 24, the data collection and storage can be performed without problems.

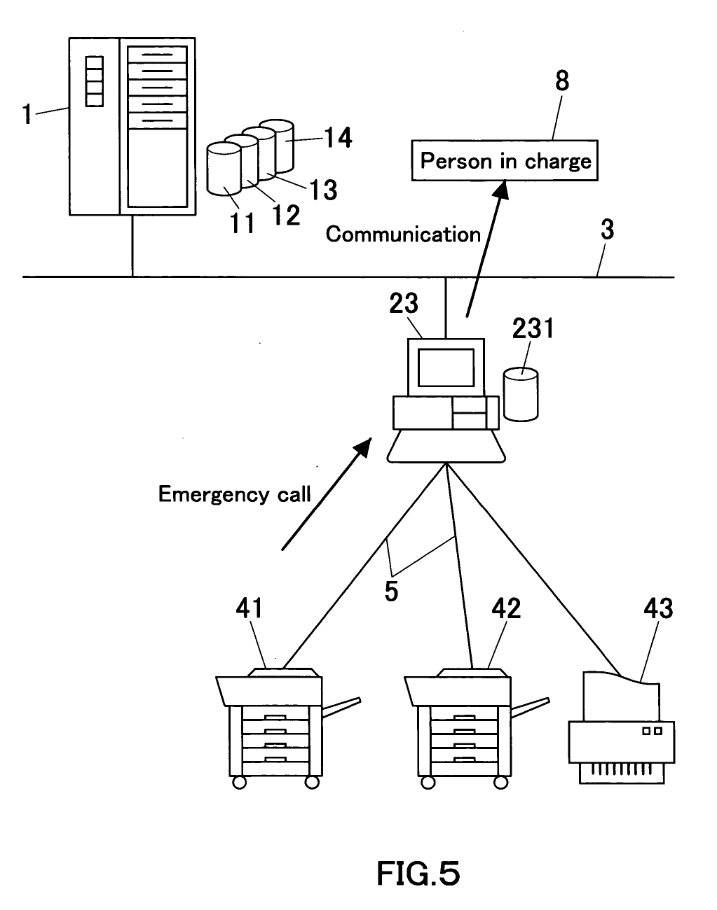

Although a user browses data in the data center 1 usually via the application server 6, when emergency call data such as a trouble call (hereinafter referred to as “emergency call data”) is transmitted from an information equipment 41 to 43 to a branch center 21 to 24, as shown in FIG. 5, it is configured such that the branch center 24 itself can discriminate and contact a maintainer 8 immediately by e-mail, facsimile, etc. Thus, this system can immediately cope with any emergency of information equipments 41 to 43. For this reason, contact information, such as a maintainer's mail address and a facsimile number, is stored in the data bases 211 to 241 of the branch centers 21 to 24. These contacts are saved also in the correspondence data bases 11 to 14 of the data center 1 synchronized in data.

The emergency call data is data to be taken out when an error occurs at the information equipments 41 to 43, and is not mere error information, such as a run-out-of-paper and a paper jam, but data which requires a repair by a serviceman. For example, at the time of errors, such as a blowout of a fuse in a motor, abnormalities of electro static charge poles, abnormalities in toner conveyance, and high temperature of fixing rollers, the information equipments 41 to 43 transmit emergency call data.

In this administration system according to this embodiment, as mentioned above, the data center 1 and the branch centers 21 and 24 hold basically the same data. However, as for unit price data to be used at the time of accounting calculation, the data can be held by the data center 1, or held not by the data center 1 but only by the branch centers 21 to 24 in this embodiment.

Namely, when a user browses accounting information via the application server 6, the system usually allows the user to browse the accounting information after performing fee calculation based on the unit price data stored in the data center 1. However, as for unit price data, each branch office or sales branch may sometimes operates. In such a case, there may be a case in which it is refused to place unit price data in the data center 1.

Accordingly, in order to cope with such a case, it can be configured such that only the branch centers 21 to 24 hold unit price data and the data center 1 refers to the unit price data if needed.

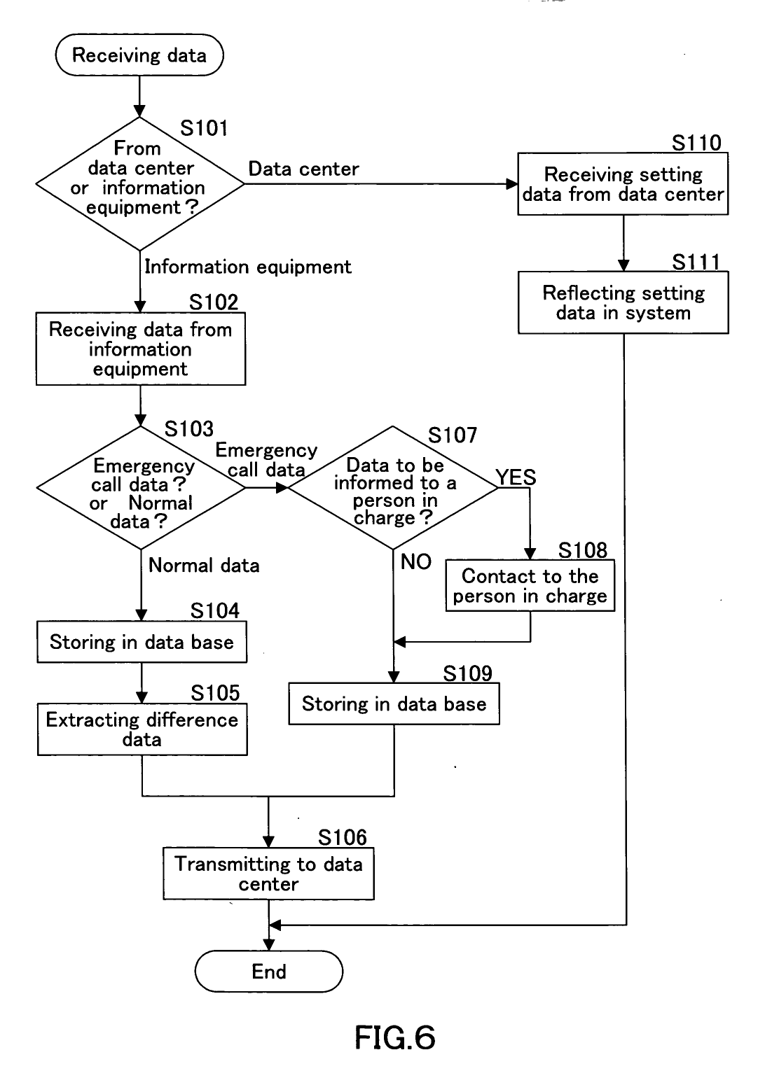

FIG. 6 is a flowchart showing operation to be performed when each branch center 21 to 24 received data. In the following explanation and drawings, a step will be referred to as “S.”

In FIG. 6, upon receiving data, at S101, the branch centers 21 to 24 discriminates whether the data come from the information equipments 41 to 43 or from the data center 1. If it is discriminated that it came from the information equipments 41 to 43, the routine proceeds to S102. However, if it is discriminated that it came from the data center 1, the routine proceeds to S110.

At S102, after processing the data from the information equipments 41 to 43, at S103, the branch center discriminates whether the received data is emergency call data or normal data. If it is normal data, the routine proceeds to S104. To the contrary, if it is emergency call data, the routine proceeds to S107.

After storing the received data in the data bases 211 to 241 at S104, the branch center compares the received data with the holding data, and performs an extraction and creation of difference data at S105. Then, at S106, the difference data is transmitted to the data center 1, and the operation is terminated.

On the other hand, in the case of emergency call data at S103, it is discriminated whether the emergency call data is data which should be informed to the person in charge of the information equipments 41 to 43 at S107. If it is not data which should be informed to a person in charge (“No” at S107), the routine proceeds to S109 to store the data in the data bases 211 to 241. Thereafter, the data is transmitted also to the data center 1 at S106, and the operation is terminated. If it is data which should be informed to a person in charge (“Yes” at S107), the routine proceeds to S108. After contacting a person in charge, the data is stored in the data bases 211 to 241 at S109, and transmitted to the data center 1 at S106.

At S101, if the data is transmitted from the data center 1, since the setting data by a user have been sent, after receiving the setting data from the data center 1 at S110, the setting data is made to reflect in the system of the branch centers 21 to 24 at S111, and the operation is terminated.

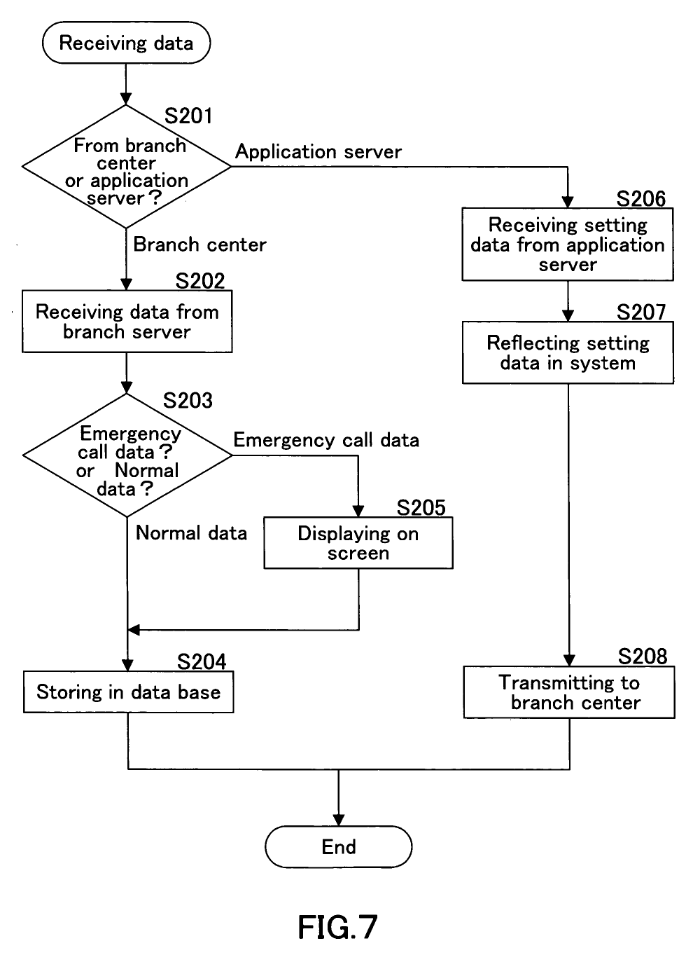

FIG. 7 is a flowchart showing operation to be performed when the data center 1 received data.

In FIG. 7, when the data center 1 received data, at S201, it is discriminated whether the data came from the branch centers 21 to 24 or form the application server 6. If it is discriminated that the data came from the branch centers 21 to 24, the routine proceeds to S202. To the contrary, if it is discriminated that it came from the application server 6, the routine proceeds to S206.

At S202, after receiving the data from the branch centers 21 to 24, it is discriminated whether the received data is emergency call data or normal data at S203. If it is discriminated that the data is normal data, the routine proceeds to S204. To the contrary, if it is discriminated that the data is emergency call data, the routine proceeds to S205.

At S204, the received data is stored in the data bases 11 and 14 corresponding to the branch centers, and the operation is terminated.

On the other hand, in the case of emergency call data as S203, after displaying of the emergency call data on a display of the data center 1, the data is stored in the data bases 11 and 14, and the operation is terminated.

At S201, in cases where data is transmitted from the application server 6, after the receiving of the data from the application server 6 at S206, the setting data is made to reflect in the system at S207. Subsequently, the data is transmitted also to the branch centers 21 and 24, and the operation is terminated.

Although one embodiment of the present invention was explained above, the present invention is not limited to the above-explained embodiment. For example, in the above-mentioned embodiment, the application server 6 is independent from the data center 1. However, in place of the above, an application server function can be provided in the data center 1.

Although the administration target devices 41 to 43 are image forming apparatus in the aforementioned embodiment, the administration target devices can be any devices, such as household appliances.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

What is claimed is:

1. An administration system for an administration target device, comprising:
at least one branch server that collects data from the administration target device; and
a data server that integrally administers the data of each branch server,
wherein each branch server and the data server are synchronized in data so that data held by one of the branch server and the data server can be held by the other.

2. An administration system for an administration target device, comprising:
at least one branch server that collects the data from the administration target device; and
a data server that integrally administers the data of each branch server,
wherein the data server holds data of each branch server in the state in which the data is separated every branch server without merging them, and processes the data as coherent data based on the data separated every branch server.

3. The administration system for an administration target device as recited in claim 2, wherein each branch server and the data server are synchronized in data so that data held by one of the branch server and the data server can be held by the other.

4. The administration system for an administration target device as recited in claim 1, wherein the branch server transmits difference data obtained by removing transmitted data from the data collected from the administration target device to the data server.

5. The administration system for an administration target device as recited in claim 2, wherein the branch server transmits difference data obtained by removing transmitted data from the data collected from the administration target device to the data server.

6. The administration system for an administration target device as recited in claim 1, wherein the branch server transmits all the data in the branch server to a new data server at the time of a change of a data server.

7. The administration system for an administration target device as recited in claim 2, wherein the branch server transmits all the data in the branch server to a new data server at the time of a change of a data server.

8. The administration system for an administration target device as recited in claim 1, wherein setting data set by a user is capable of being transmitted from the user terminal to the data server, and the transmitted setting data is reflected in the data server.

9. The administration system for an administration target device as recited in claim 2, wherein setting data set by a user is capable of being transmitted from the user terminal to the data server, and the transmitted setting data is reflected in the data server.

10. The administration system for an administration target device as recited in claim 8, wherein the setting data is transmitted to the branch server from the data server.

11. The administration system for an administration target device as recited in claim 9, wherein the setting data is transmitted to the branch server from the data server.

12. The administration system for an administration target device as recited in claim 1, wherein the data server can collect data directly from the administration target device via the branch server.

13. The administration system for an administration target device as recited in claim 2, wherein the data server can collect data directly from the administration target device via the branch server.

14. The administration system for an administration target device as recited in claim 1, wherein the branch server can contact a person in charge of an administration target device according to data from the administration target device.

15. The administration system for an administration target device as recited in claim 2, wherein the branch server can contact a person in charge of an administration target device according to data from the administration target device.

16. The administration system for an administration target device as recited in claim 1, wherein only the branch server holds unit price data at the time of accounting calculation, and the branch server transmits the unit price data according to a request from the data server.

17. The administration system for an administration target device as recited in claim 2, wherein only the branch server holds unit price data at the time of accounting calculation, and the branch server transmits the unit price data according to the request from a data server.

18. A data server for use in an administration system for an administration target device, comprising:
at least one branch server that collects data from the administration target device; and
a data server that integrally administers the data of each branch server,
wherein each branch server and the data server are synchronized in data so that data held by one of the branch server and the data server can be held by the other.

19. A data server for use in an administration system for an administration target device, comprising:
at least one branch server that collects data from the administration target device; and
a data server that integrally administers the data of each branch server,
wherein the data server holds the data of each branch server in the state in which the data is separated every branch server without merging them, and processes the data as coherent data based on the data separated every branch server.

20. A branch server for use in an administration system for an administration target device, comprising:
at least one branch server that collects data from the administration target device; and
a data server that integrally administers the data of each branch server,
wherein each branch server and the data server are synchronized in data so that data held by one of the branch server and the data server can be held by the other.

21. A branch server for use in an administration system for an administration target device, comprising:
at least one branch server that collects data from the administration target device; and
a data server that integrally administers the data of each branch server,
wherein the data server holds the data of each branch server in the state in which the data is separated every branch server without merging them, and processes the data as coherent data based on the data separated every branch server.
